(19) United States
(12) Patent Application Publication
(10) Pub. No.: US 2023/0216127 A1
(43) Pub. Date: Jul. 6, 2023

(54) RECHARGEABLE BATTERY MODULE AND ELECTRIC VEHICLE AND ENERGY STORAGE SYSTEM USING THE SAME

(71) Applicant: SAMSUNG SDI CO., LTD., Yongin-si (KR)

(72) Inventors: Jeehoon JEON, Yongin-si (KR); Wun Seok JEONG, Yongin-si (KR); Taeho JI, Yongin-si (KR); Soodeok MOON, Yongin-si (KR); Jungkyun JUNG, Yongin-si (KR); Janggun AHN, Yongin-si (KR); Jaelim RYU, Yongin-si (KR); Gwangtaek YOON, Yongin-si (KR); Kye Youn LEE, Yongin-si (KR)

(21) Appl. No.: 18/148,373

(22) Filed: Dec. 29, 2022

(30) Foreign Application Priority Data
Dec. 30, 2021 (KR) 10-2021-0193103

(51) Int. Cl. H01M 50/249; H01M 50/209; H01M 50/244; H01M 50/262; H01M 50/271; H01M 50/296; H01M 50/242; H01M 50/342; H01M 10/613; H01M 10/625; H01M 10/6556; H01M 10/6567; H01M 50/258; H01M 10/6554; B60K 1/04

(52) U.S. Cl. CPC H01M 50/249; H01M 50/209; H01M 50/244; H01M 50/262; H01M 50/271; H01M 50/296; H01M 50/242; H01M 50/342; H01M 10/613; H01M 10/625; H01M 10/6556; H01M 10/6567; H01M 50/258; H01M 10/6554; B60K 1/04; H01M 2220/20; H01M 2200/20; B60K 2001/005

(57) ABSTRACT

A rechargeable battery module includes: a bottom plate supporting a plurality of cells and having mounting holes at both ends; a pair of side plates coupled to both sides of the bottom plate; a pair of end plates coupled to the bottom plate and the side plates at both sides; a mounting plate coupled to the bottom plate and the pair of side plates between the pair of end plates, the mounting plate having a through installation hole through which a mount member extends therethrough from the outside thereof to fasten the rechargeable battery module to a platform of an electric vehicle or a rack of an energy storage system; a top cover coupled to the side plates, the end plates, and the mounting plate; and a final terminal connected to a bus bar connecting electrode terminals of the cells.

### CROSS-REFERENCE TO RELATED APPLICATION

This application claims priority to and the benefit of Korean Patent Application No. 10-2021-0193103, filed in the Korean Intellectual Property Office on Dec. 30, 2021, the entire content of which is incorporated herein by reference.

### BACKGROUND

### 1. Field

Aspects of embodiments of the present disclosure relate to a rechargeable battery module and electric vehicle and energy storage system using the rechargeable battery module.

### 2. Description of the Related Art

A rechargeable battery is a battery that is designed to be repeatedly charged and discharged, different from a primary battery. A low-capacity rechargeable battery may be used in a small, portable electronic device, such as a mobile phone, a laptop computer, and a camcorder. A large-capacity and high-density rechargeable battery may be used as a power source or for energy storage for driving a motor of a hybrid vehicle and an electric vehicle.

As an example, a rechargeable battery includes: an electrode assembly including a positive electrode, a negative electrode, and a separator interposed between the positive and negative electrodes; a case accommodating the electrode assembly; and an electrode terminal electrically connected to the electrode assembly.

The rechargeable battery performs charging and discharging through an electrochemical reaction between the positive and negative electrodes and an electrolyte solution injected into the inside of the case. The case may have, for example, a cylindrical or rectangular shape depending on its desired application.

The rechargeable battery may be used as (or used in) a rechargeable battery module including a plurality of unit battery cells connected to each other in series and/or in parallel to drive a motor of a hybrid vehicle, as an example, which requires a relatively high energy density. For example, the rechargeable battery module is formed by connecting electrode terminals of a plurality of unit battery cells, the number and connection arrangement of unit battery cells corresponding to a desired amount of power, to each other to realize a relatively high-power rechargeable battery module, for example, for an electric vehicle.

As an example, the rechargeable battery module is configured of a unit product, by stacking a plurality of cells, mounting and assembling them in a housing structure together with related parts, and then electrically connecting them in series and/or in parallel. There are various manufacturing methods of rechargeable battery modules for each cell type and each manufacturer, and a plurality of the rechargeable battery modules are connected to each other in series and/or parallel to form a rechargeable battery pack.

Typically, a rechargeable battery module is made of a rechargeable battery pack and assembled in an electric vehicle. The structure of the rechargeable battery pack is being improved to facilitate assembly into and separation of the rechargeable battery module from the electric vehicle. However, because the rechargeable battery module is positioned inside the rechargeable battery pack, in order to assemble and maintain the rechargeable battery module, the rechargeable battery pack must be separated from the electric vehicle and the rechargeable battery pack must be disassembled.

Therefore, a lot of effort is required for assembly and maintenance of the rechargeable battery, and the rechargeable battery module may be suitable for use in an energy storage system when it reaches 70 to 80% of a state of health (SOH) of the electric vehicle.

The above information disclosed in this Background section is for enhancement of understanding of the background of the present disclosure, and therefore, it may contain information that does not form the prior art that is already known to a person of ordinary skill in the art.

### SUMMARY

An embodiment of the present disclosure provides a rechargeable battery module that may be directly assembled in a dedicated platform of an electric vehicle in a module state. An embodiment of the present disclosure also provides a rechargeable battery module that may be easily converted to an energy storage system in an electric vehicle. An embodiment of the present disclosure also provides an electric vehicle and an energy storage system to which the rechargeable battery module is applied.

An embodiment of the present disclosure provides a rechargeable battery module including: a plurality of cells; a bottom plate supporting the plurality of cells and having mounting holes at both ends thereof in a length direction; a pair of side plates coupled to both sides of the bottom plate in a width direction; a pair of end plates coupled to the bottom plate and the pair of side plates at both sides in the length direction; a mounting plate coupled to the bottom plate and the pair of side plates between the pair of end plates, the mounting plate having a through installation hole through which a mount member extends therethrough from the outside thereof to fasten the rechargeable battery module to a platform of an electric vehicle or a rack of an energy storage system; a top cover coupled to the pair of side plates, the pair of end plates, and the mounting plate; and a final terminal connected to a bus bar connecting electrode terminals of the plurality of cells.

The final terminal may extend from a lower side of the bottom plate to above the bottom plate.

The bottom plate may have a plate-shaped support part supporting the plurality of cells and a buffer part forming a buffer space at an outer side of the support part, and the buffer part may be connected to the support part.

The bottom plate may have a protrusion protruding in the width direction, the side plates may each have a coupling groove coupled to the protrusion and a flange part extending around a lower surface of the bottom plate, and the flange part may be fastened to the bottom plate with a fastening member.

The final terminal may include: a first connecting member connected to the bus bar and bent toward the bottom plate; and a second connecting member exposed to the outside of the bottom plate and extending through the bottom plate and electrically connected to the first connecting member.

The second connecting member may include a female coupling part at an inner end thereof, and the first connecting member may include a male coupling part coupled to the female coupling part.

The female coupling part and the male coupling part may be laser welded to each other.

The mounting plate may be fixedly coupled by a coupling member coupled to a groove respectively formed on an upper surface of the bottom plate and a lower surface of the mounting plate facing the upper surface, and the mounting plate may be fastened to a fastening member extending through at least one of the side plates.

The mount member may be installed below the platform or at a side of the rack by extending through the mounting plate and the top cover.

The end plates may be on the bottom plate at a lower end thereof, may be fastened to a fastening member extending through the side plates, and may be outside the first connecting member and the second connecting member of the final terminal. The first and second connecting members may be coupled to each other.

The end plates may include a vent configured to discharge a gas from an inner space defined by the bottom plate, the pair of side plates, the pair of end plates, and the top cover during a cell event.

The vent may include: a housing on the end plates and having an outlet at a center thereof; and a cap coupled to the outside of the housing and configured to open according to a gas pressure in the inner space.

The rechargeable battery module may further include: a cooling fluid connecting passage at both ends of the side plates to be connected to a cooling channel in the side plates; and a cooling fluid port connected to the cooling fluid connecting passage and outside the bottom plate to supply and discharge a cooling fluid.

Another embodiment of the present disclosure provides an electric vehicle including: a plurality of rechargeable battery modules raised from a lower portion of a platform of the electric vehicle and mounted on the platform by mount members at both ends in a length direction; and a cooling pipe connecting cooling fluid ports provided below the rechargeable battery module to each other.

The electric vehicle may further include a protection plate covering the cooling pipe and the plurality of rechargeable battery modules below the cooling pipe, and the protection plate may be mounted on the platform.

The electric vehicle may further include another mount member extending through a through installation hole in a mounting plate of the rechargeable battery module from below to be fastened to the platform.

Another embodiment of the present disclosure provides an energy storage system including: a rack of the energy storage system; and a plurality of rechargeable battery modules configured to be moved from a side of the rack to be mounted on the rack by mount members at both ends in a length direction.

The energy storage system may further include another mount member extending through a through installation hole in a mounting plate of the rechargeable battery module from a side thereof to be further fastened to the rack.

Because the rechargeable battery module according to embodiments of the present disclosure has a mounting hole in a bottom plate and a through installation hole in a mounting plate, the rechargeable battery module may be directly assembled and mounted on a platform by a mount member passing through the mounting hole and the through installation hole while being raised from a lower portion of the platform of an electric vehicle. For example, the rechargeable battery module may be directly assembled in and detached from the platform of the electric vehicle in a module state.

In addition, because the rechargeable battery module according to embodiments of the present disclosure has a mounting hole in a bottom plate and a through installation hole in a mounting plate, the rechargeable battery module may be detached from an electric vehicle at the end of its service life and directly assembled and mounted on a rack by a mount member passing through the mounting hole and the through installation hole while being moved from a side of the rack of an energy storage system. For example, the rechargeable battery module may be detached from the platform of the electric vehicle in a module state and may be directly assembled in and detached from the rack of the energy storage system.

### BRIEF DESCRIPTION OF THE DRAWINGS

FIG. 1 is an exploded perspective view of a rechargeable battery module according to an embodiment of the present disclosure.

FIG. 2 is a perspective view of the rechargeable battery module shown in FIG. 1.

FIG. 3 is a partial exploded perspective view of a final terminal.

FIG. 4 is a partial perspective view of a final terminal and an end plate.

FIG. 5 is a partial perspective view of a final terminal viewed from a lower portion thereof.

FIG. 6 is a bottom view of the rechargeable battery module shown in FIG. 1.

FIG. 7 is a partial perspective view of a mounting plate of the rechargeable battery module shown in FIG. 1.

FIG. 8 is a cross-sectional view taken along the line VIII-VIII of FIG. 7.

FIG. 9 is a partial perspective view of an end plate of the rechargeable battery module shown in FIG. 1.

FIG. 10 is a cross-sectional view taken along the line X-X of FIG. 9.

FIG. 11 is a cross-sectional view taken along the line XI-XI of FIG. 2.

FIG. 12 is a bottom view of a rechargeable battery module installed in an electric vehicle according to an embodiment of the present disclosure.

FIG. 13 is a bottom view showing cooling fluid ports of the rechargeable battery module shown in FIG. 12.

FIG. 14 is an exploded partial perspective view of a cooling fluid pipe connected to the cooling fluid ports shown in FIG. 12.

FIG. 15 is a partial perspective view of a protection plate installed below the cooling fluid pipe shown in FIG. 14.

FIG. 16 is a perspective view of a rechargeable battery module installed in an energy storage system according to an embodiment of the present disclosure.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure. Thus, the drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

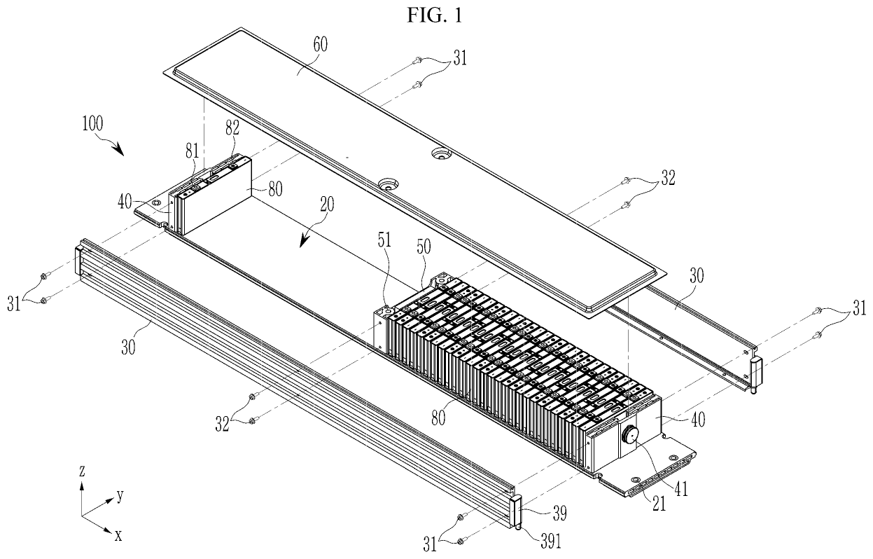

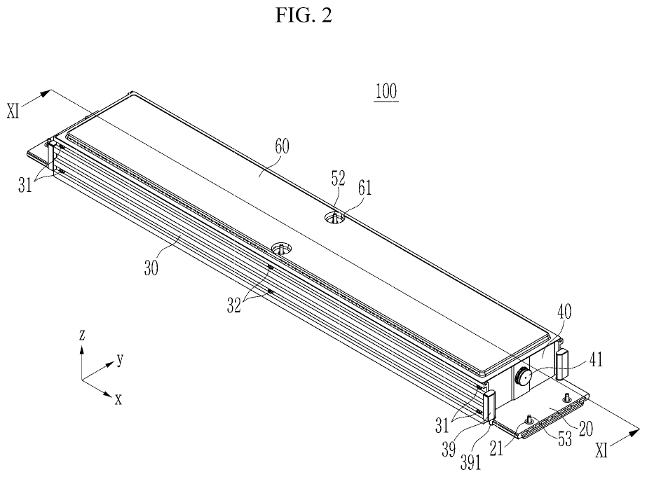

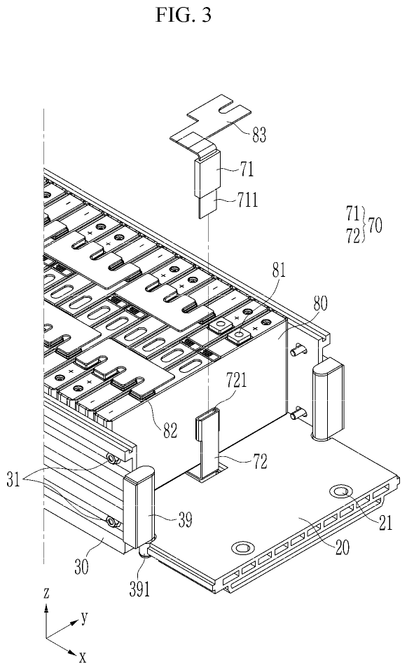

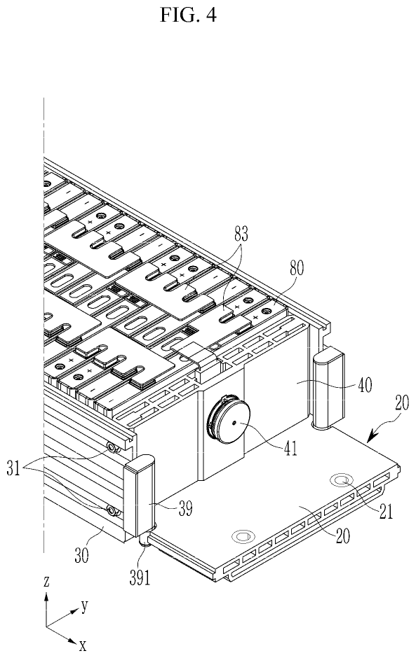

FIG. 1 is an exploded perspective view of a rechargeable battery module according to an embodiment of the present disclosure, FIG. 2 is a perspective view of the rechargeable battery module shown in FIG. 1, FIG. 3 is an exploded partial perspective view of a final terminal of the rechargeable battery module, and FIG. 4 is a partial perspective view of the final terminal and an end plate.

Referring to FIG. 1 to FIG. 4, a rechargeable battery module 100 according to an embodiment includes a bottom plate 20, a side plate (e.g., two side plates) 30, an end plate (e.g., two end plates) 40, a mounting plate 50, a top cover 60, and a final terminal 70.

The bottom plate 20 supports a plurality of cells 80 configured as a rechargeable battery and has mounting holes (e.g., mounting openings) 21 at both ends (e.g., opposite ends) thereof in a length direction (e.g., an x-axis direction). The bottom plate 20 determines a length of the rechargeable battery module 100 in the x-axis direction.

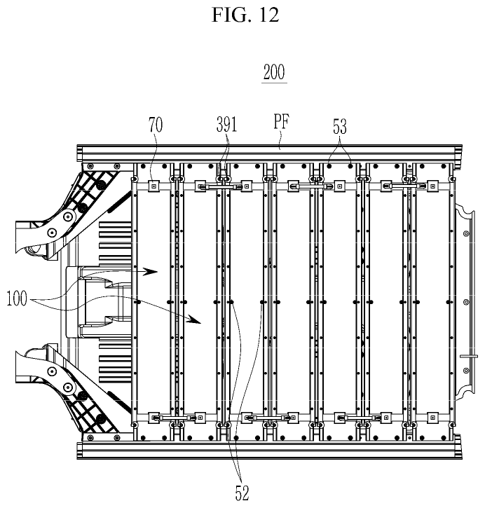

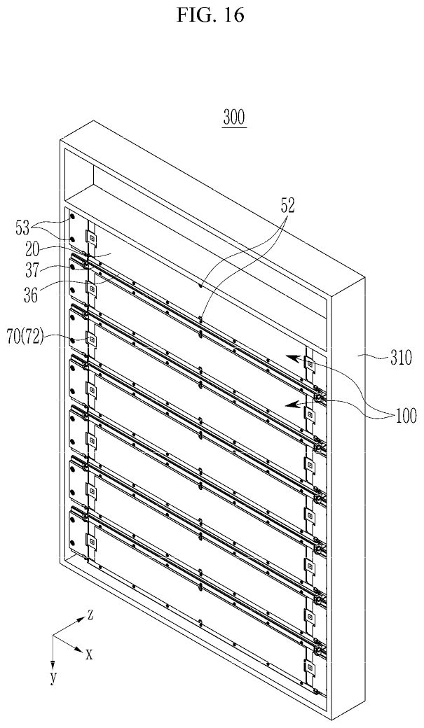

The bottom plate 20 may be fastened to a platform PF (see, e.g., FIG. 12) of an electric vehicle 200 or a rack 310 (see, e.g., FIG. 16) of an energy storage system 300 through the mounting holes 21 to assemble the rechargeable battery module 100 to the platform PF or the rack 310.

The side plates 30 are provided as a pair and are coupled to both sides of the bottom plate 20 in a width direction (e.g., a y-axis direction). The side plate 30 determines a height of the rechargeable battery module 100 in a height direction (e.g., a z-axis direction).

The end plates 40 are provided as a pair and are disposed on an upper surface of the bottom plate 20 at both sides of the bottom plate 20 in the length direction (e.g., the x-axis direction) to be disposed and coupled between the pair of side plates 30. For example, the side plate 30 is coupled to the end plate 40 with a fastening member (e.g., a fastener) 31.

The mounting plate 50 is disposed between the pair of end plates 40 on the upper surface of the bottom plate 20 and is coupled between the pair of side plates 30. For example, the side plate 30 is coupled to the mounting plate 50 by a fastening member (e.g., a fastener) 32.

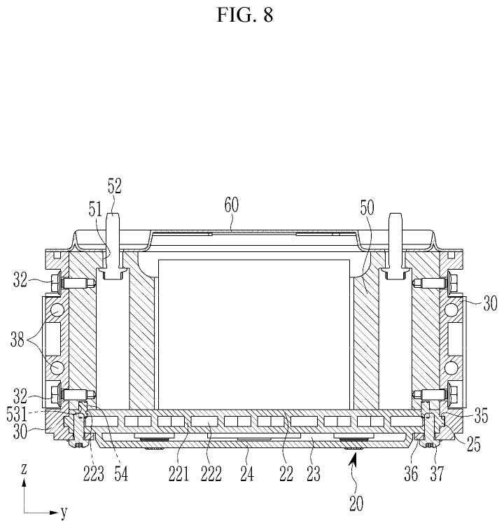

The mounting plate 50 has a through installation hole (e.g., an installation opening) 51 penetrating therethrough in the z-axis direction so that a mounting member 52 (see, e.g., FIG. 8) may extend through the rechargeable battery module 100, that is, to extend below the bottom plate 20 to be fastened to the platform PF of the electric vehicle 200 or the rack 310 of the energy storage system 300.

The mounting plate 50 is provided to prevent sagging of the bottom plate 20 when the length of the rechargeable battery module 100 is relatively long. In the illustrated embodiment, the mounting plate 50 is provided at a center of the bottom plate 20 along its length in the x-axis direction. One or a plurality of mounting plates 50 may be provided according to the length of the rechargeable battery module 100.

The top cover 60 is disposed and coupled on the pair of side plates 30, the pair of end plates 40, and the mounting plate 50. The top cover 60 has a through hole (e.g., an opening) 61 corresponding to the through installation hole 51 in the mounting plate 50 to allow the mount member 52 to pass therethrough.

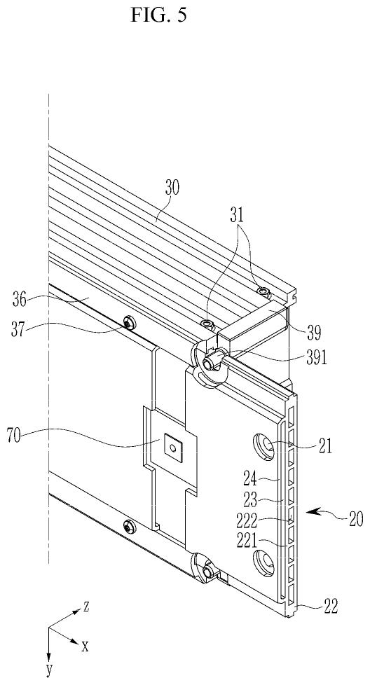

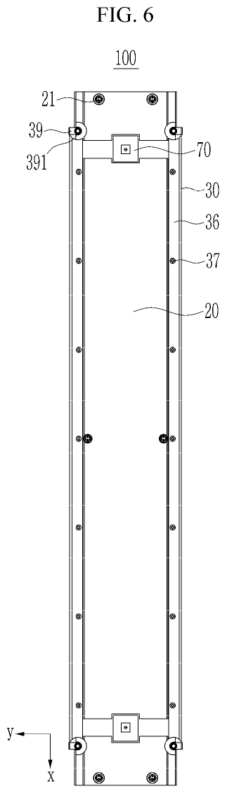

FIG. 5 is a partial perspective view of a final terminal viewed from a lower portion thereof, and FIG. 6 is a bottom view of the rechargeable battery module shown in FIG. 1. Referring to FIG. 3 to FIG. 6, the final terminal 70 is finally connected to a bus bar 83 connecting electrode terminals 81 and 82 of the cells 80. The final terminal 70 is drawn out of a lower side of the bottom plate 20.

As an example, the final terminal 70 includes a first connecting member 71 and a second connecting member 72. The first connecting member 71 is connected to a bus bar 83 and is bent downwardly toward the bottom plate 20. The second connecting member 72 is exposed to the outside of the bottom plate 20 and is installed through the bottom plate 20 to be electrically connected to the first connecting member 71.

In one embodiment, the second connecting member 72 includes a female coupling part 721 at an inner end thereof, and the first connecting member 71 includes a male coupling part 711 coupled to the female coupling part 721 to be electrically and mechanically connected thereto. The female coupling part 721 and the male coupling part 711 may be laser welded to each other while being coupled to each other.

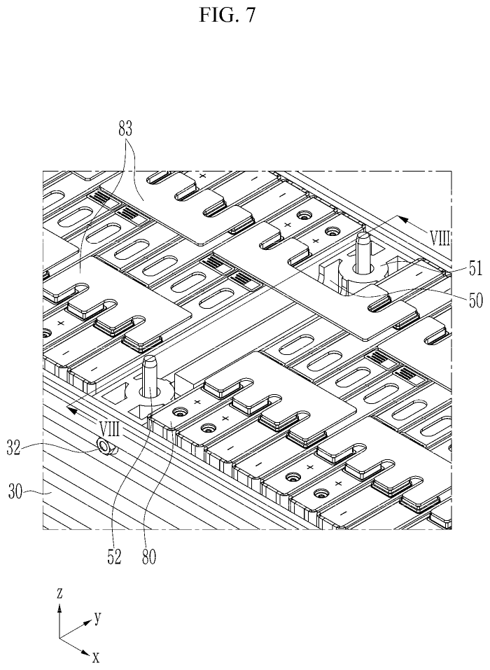

FIG. 7 is a partial perspective view of a mounting plate in the rechargeable battery module shown in FIG. 1, and FIG. 8 is a cross-sectional view taken along the line VIII-VIII of FIG. 7. Referring FIG. 7 and FIG. 8, the mounting plate 50 is fixed by a coupling member 54 and is coupled in a vertical direction with the coupling member 54 coupled to grooves 223 and 531 respectively formed on an upper surface of the bottom plate 20 and a lower surface thereof facing the upper surface. In addition, the mounting plate 50 is fastened to the fastening member 32 passing through the side plate 30.

In one embodiment, the bottom plate 20 has a plate-shaped support part 22 supporting the plurality of cells 80 and a buffer part 24 that forms a buffer space 23 at one side of (e.g., at an outer side of) the support part 22 and is connected to the support part 22.

The support part 22 further includes a buffer space 222 partitioned by a partition wall 221 extending in the x-axis direction. Accordingly, the bottom plate 20 is has a stacked structure including the buffer part 24 of a lowermost side, the buffer space 23, the partition wall 221, the buffer space 222, and the support part 22.

The buffer part 24 provides a safety zone for protecting the electric vehicle 200 from an impact at a lower portion thereof through the buffer space 23. For example, the buffer part 24 may reduce or minimize cell damage at the bottom of the rechargeable battery module 100 when a structure of a protection plate 120, to be described later, collapses or fails due to a lower impact.

The bottom plate 20 has a protrusion 25 that protrudes in the width direction (e.g., the y-axis direction) and extends in the length direction (e.g., x-axis direction), and the side plate 30 has a coupling groove 35 coupled to (e.g., accommodating) the protrusion 25 and includes a flange part 36 surrounding (e.g., extending around a periphery of) a lower surface thereof. The flange part 36 is fastened to the bottom plate 20 with a fastening member 37. Accordingly, the side plate 30 is firmly coupled while surrounding the bottom plate 20 at both sides of the bottom plate 20 in the width direction.

The mount member 52 is installed below the platform PF or at a side of the rack 310 through the through-hole 51 in the mounting plate 50 and the through-hole 61 in the top cover 60. The mount member 52 may be a bolt to be screwed into the platform PF or the rack 310 via the through installation hole 51 and the through hole 61 to assemble the rechargeable battery module 100 to the electric vehicle 200 or the energy storage system 300.

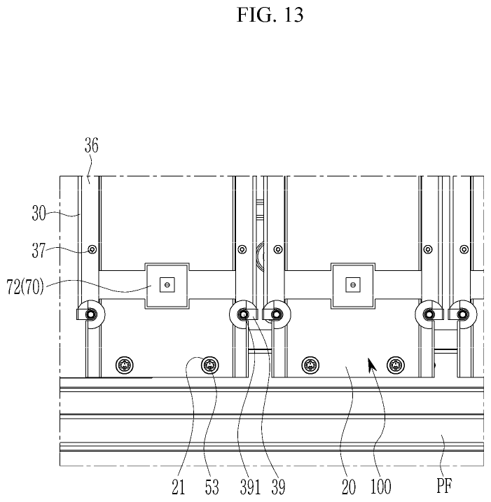

Another mounting member 53 is screwed to the platform PF or the rack 310 via the mounting hole 21 so that the rechargeable battery module 100 is assembled and installed in the electric vehicle 100 or the energy storage system 300 (see, e.g., FIG. 13 and FIG. 16).

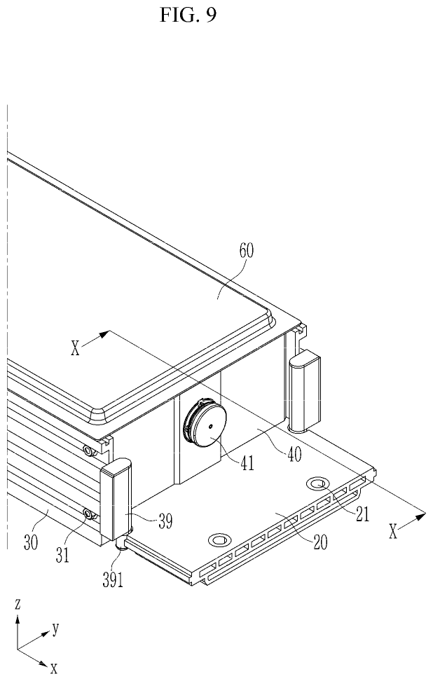

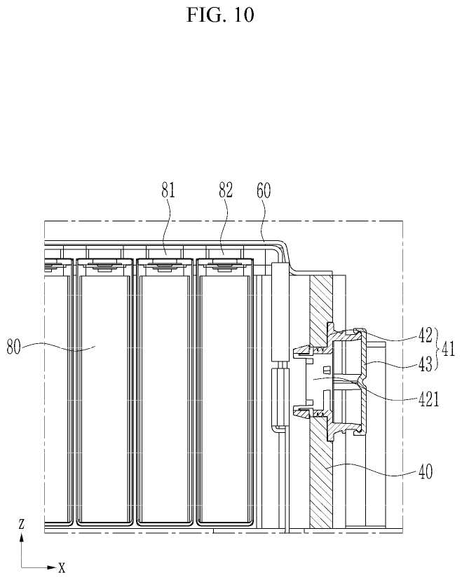

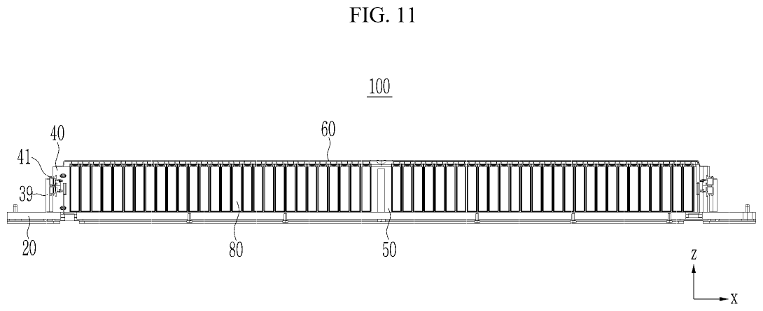

FIG. 9 is a partial perspective view of an end plate of the rechargeable battery module shown in FIG. 1, FIG. 10 illustrates a cross-sectional view taken along the line X-X of FIG. 9, and FIG. 11 is a cross-sectional view taken along the line XI-XI of FIG. 2.

Referring to FIG. 1, FIG. 4, and FIG. 9 to FIG. 11, a lower portion of the end plate 40 is disposed on the bottom plate 20, is fastened to the fastening member 31 penetrating the side plate 30, and is disposed on the outside of the final terminal 70 formed by the first connecting member 71 and the second connecting member 72, which are coupled to each other.

The end plate 40 includes a vent 41 for discharging a gas from an inner space formed by the bottom plate 20, the pair of side plates 30, the pair of end plates 40, and the top cover 60 during a cell event.

The vent 41 includes a housing 42 and a cap 43. The housing 42 is installed through the end plate 40 and has an outlet 421 at a center thereof. The cap 43 is coupled to the outside of the housing 42 to close the outlet 421 but is configured to open (or burst) due a gas pressure in the inner space to quickly discharge gas generated during an event to the outside, thereby preventing secondary accidents.

Referring back to FIG. 8 and FIG. 9, the pair of side plates 30 are provided with a cooling channel 38 for cooling the cells 80 by circulating a cooling fluid therethrough. The rechargeable battery module 100 includes a cooling fluid connecting passage 39 connected to the cooling channel 38 at both ends of the side plate 30 and further includes a cooling fluid port 391 connected to the cooling fluid connecting passage 39.

The cooling fluid port 391 is installed in (e.g., opens in) a downward direction, that is, outward from the bottom plate 20, to supply and discharge the cooling fluid. Accordingly, the assembly of a cooling pipe 110 to the cooling fluid port 391 is facilitated.

In addition, because the assembly direction of the cooling pipe 110 is in the z-axis direction that rises (e.g., extends upwardly) from the lower portion of the electric vehicle 200, it is easy to detach and attach the cooling pipe 110, and any leaked cooling fluid that may occur at a fastening portion with the cooling fluid port 381 falls downwardly. Thus, the cooling fluid port 391 and the cooling pipe 110 do not affect the cell 80 due to a leakage of the cooling fluid.

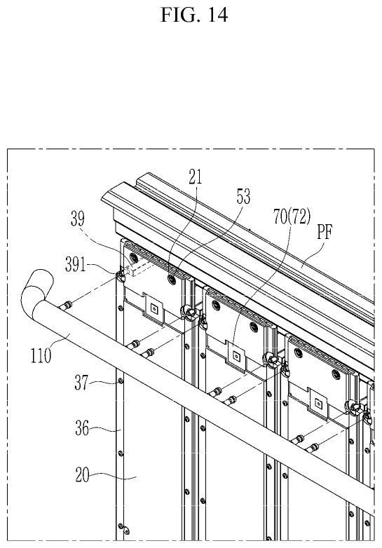

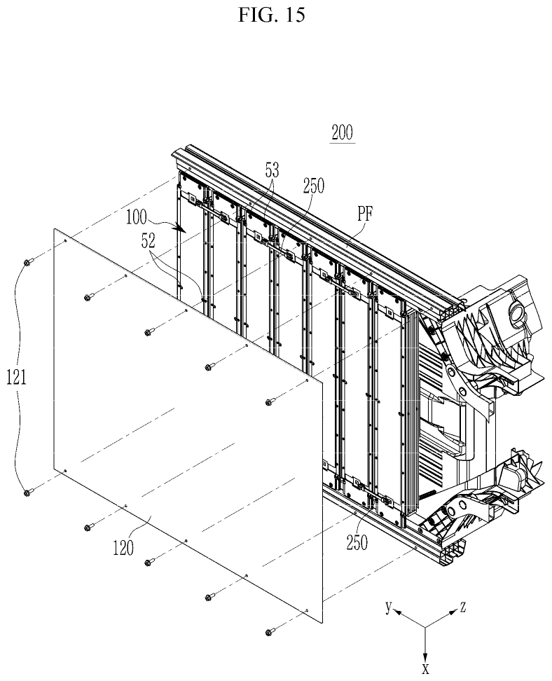

FIG. 12 is a bottom view of a rechargeable battery module installed in an electric vehicle according to an embodiment of the present disclosure, FIG. 13 is a bottom view showing cooling fluid ports formed downwardly from the rechargeable battery module in FIG. 12, FIG. 14 is an exploded partial perspective view of a cooling fluid pipe connected to the cooling fluid ports shown in FIG. 12, and FIG. 15 is a partial perspective view of a protection plate installed below the cooling fluid pipe shown in FIG. 14.

Referring to FIG. 12 to FIG. 15, the electric vehicle 200 in which the rechargeable battery module 100 is assembled and mounted is shown. The electric vehicle 200 includes the plurality of rechargeable battery modules 100 and the cooling pipe 110 that are raised from the lower portion of the platform PF to be mounted on the platform PF.

The cooling pipe 110 connects the cooling fluid ports 391, provided below the rechargeable battery module 100, to each other so that the cooling fluid may be discharged to one side thereof.

The electric vehicle 200 further includes the protection plate 120. The protection plate 120 covers the cooling pipe 110 and the plurality of rechargeable battery modules 100 and is arranged below the cooling pipe 110 and is mounted on the platform PF by a fastening member 121.

The electric vehicle 200 includes the mount member 52 that penetrates the through installation hole 51 provided in the mounting plate 50 of the rechargeable battery module 100 from below and is fastened to the platform PF. The protection plate 120 is mounted on the platform PF after the rechargeable battery module 100 is installed by the mount member 52.

Accordingly, the protection plate 120 is positioned below the electric vehicle 200 and protects a connecting bus bar 250 and the cooling pipe 110 connecting the rechargeable battery modules 100. The protection plate 120 protects the lower portion of the electric vehicle 200.

FIG. 16 is a perspective view a rechargeable battery module installed in an energy storage system according to an embodiment of the present disclosure. Referring to FIG. 16, the energy storage system 300 in which the rechargeable battery module 100 is assembled and mounted is shown. The energy storage system 300 includes the rack 310, and the plurality of rechargeable battery modules 100 are mounted to the rack 310 by moving from the side of the rack 310.

The plurality of rechargeable battery modules 100 are separated from the platform PF when they reach 70-80% of their initial state of health (SOH), which may be when the cycle-life of the electric vehicle 200 is exhausted, and the rechargeable battery modules 100 may then be installed and used in the rack 310. The rechargeable battery module 100 is mounted and used below the platform PF of the electric vehicle 200 such that it may be separated downwardly to be moved and mounted to the side of the rack 310 of the energy storage system 300.

While the present disclosure has been described in connection with what is presently considered to be practical embodiments, it is to be understood that the present disclosure is not limited to the disclosed embodiments but is intended to cover various modifications and equivalent arrangements included within the spirit and scope of the appended claims and their equivalents.

Description of Some Reference Symbols

| | |
|---|---|
| 20: bottom plate | 22: support part |
| 23: buffer Space | 24: buffer part |
| 25: protrusion | 30: side plate |
| 21: mounting hole | 31, 32, 37, 121: fastening member |
| 35: coupling groove | 36: flange part |
| 38: cooling channel | 39: cooling fluid connecting passage |
| 40: end plate | 41: vent |
| 42: housing | 43: cap |
| 50: mounting plate | 51: through installation hole |
| 52: mount member | 53: mount member |
| 54: coupling member | 60: top cover |
| 61: through-hole | 70: final terminal |
| 71, 72: first and second connecting | |
| members | |
| 80: cell | |
| 81, 82: electrode terminal | 83: bus bar |
| 100: rechargeable battery module | |
| 110: cooling pipe | |
| 120: protection plate | 200: electric vehicle |
| 221: partition wall | 222: buffer space |
| 223, 531: groove | 250: connecting bus bar |
| 300: energy storage system | 310: rack |
| 391: cooling fluid port | 421: outlet |
| 711: male coupling part | 721: female coupling part |
| PF: platform | |

What is claimed is:

1. A rechargeable battery module comprising:
a plurality of cells;
a bottom plate supporting the plurality of cells and having mounting holes at both ends thereof in a length direction;
a pair of side plates coupled to both sides of the bottom plate in a width direction;
a pair of end plates coupled to the bottom plate and the pair of side plates at both sides in the length direction;
a mounting plate coupled to the bottom plate and the pair of side plates between the pair of end plates, the mounting plate having a through installation hole through which a mount member extends therethrough from the outside thereof to fasten the rechargeable battery module to a platform of an electric vehicle or a rack of an energy storage system;
a top cover coupled to the pair of side plates, the pair of end plates, and the mounting plate; and
a final terminal connected to a bus bar connecting electrode terminals of the plurality of cells.

2. The rechargeable battery module of claim 1, wherein the final terminal extends from a lower side of the bottom plate to above the bottom plate.

3. The rechargeable battery module of claim 1, wherein the bottom plate has a plate-shaped support part supporting the plurality of cells and a buffer part forming a buffer space at an outer side of the support part, the buffer part being connected to the support part.

4. The rechargeable battery module of claim 3, wherein the bottom plate has a protrusion protruding in the width direction,
wherein the side plates each have a coupling groove coupled to the protrusion and a flange part extending around a lower surface of the bottom plate, and
wherein the flange part is fastened to the bottom plate with a fastening member.

5. The rechargeable battery module of claim 1, wherein the final terminal comprises:
a first connecting member connected to the bus bar and bent toward the bottom plate; and
a second connecting member exposed to the outside of the bottom plate and extending through the bottom plate and electrically connected to the first connecting member.

6. The rechargeable battery module of claim 5, wherein the second connecting member comprises a female coupling part at an inner end thereof, and
wherein the first connecting member comprises a male coupling part coupled to the female coupling part.

7. The rechargeable battery module of claim 6, wherein the female coupling part and the male coupling part are laser welded to each other.

8. The rechargeable battery module of claim 5, wherein the mounting plate is fixedly coupled by a coupling member coupled to a groove respectively formed on an upper surface of the bottom plate and a lower surface of the mounting plate facing the upper surface, and
wherein the mounting plate is fastened to a fastening member extending through at least one of the side plates.

9. The rechargeable battery module of claim 5, wherein the mount member is installed below the platform or at a side of the rack by extending through the mounting plate and the top cover.

10. The rechargeable battery module of claim 5, wherein the end plates are on the bottom plate at a lower end thereof, are fastened to a fastening member extending through the side plates, and are outside the first connecting member and the second connecting member of the final terminal, and
wherein the first and second connecting members are coupled to each other.

11. The rechargeable battery module of claim 10, wherein the end plates comprise a vent configured to discharge a gas from an inner space defined by the bottom plate, the pair of side plates, the pair of end plates, and the top cover during a cell event.

12. The rechargeable battery module of claim 11, wherein the vent comprises:
a housing on the end plates and having an outlet at a center thereof; and
a cap coupled to the outside of the housing and configured to open according to a gas pressure in the inner space.

13. The rechargeable battery module of claim 1, further comprising:
a cooling fluid connecting passage at both ends of the side plates to be connected to a cooling channel in the side plates; and
a cooling fluid port connected to the cooling fluid connecting passage and outside the bottom plate to supply and discharge a cooling fluid.

14. An electric vehicle comprising:
a plurality of rechargeable battery modules raised from a lower portion of a platform of the electric vehicle and mounted on the platform by mount members at both ends in a length direction; and
a cooling pipe connecting cooling fluid ports provided below the rechargeable battery module to each other.

15. The electric vehicle of claim 14, further comprising a protection plate covering the cooling pipe and the plurality of rechargeable battery modules below the cooling pipe, the protection plate being mounted on the platform.

16. The electric vehicle of claim 14, further comprising another mount member extending through a through installation hole in a mounting plate of the rechargeable battery module from below to be fastened to the platform.

17. An energy storage system comprising:
a rack of the energy storage system; and
a plurality of rechargeable battery modules configured to be moved from a side of the rack to be mounted on the rack by mount members at both ends in a length direction.

18. The energy storage system of claim 17, further comprising another mount member extending through a through installation hole in a mounting plate of the rechargeable battery module from a side thereof to be further fastened to the rack.
